(19) United States
(12) Patent Application Publication
(10) Pub. No.: US 2021/0239488 A1
(43) Pub. Date: Aug. 5, 2021

(54) DISPLAY CONTROL DEVICE, DISPLAY CONTROL SYSTEM, AND DISPLAY CONTROL METHOD

(71) Applicant: MITSUBISHI ELECTRIC CORPORATION, Tokyo (JP)

(72) Inventor: Takeshi YAMAMOTO, Tokyo (JP)

(73) Assignee: MITSUBISHI ELECTRIC CORPORATION, Tokyo (JP)

(21) Appl. No.: 17/052,033

(22) PCT Filed: May 24, 2018
(86) PCT No.: PCT/JP2018/020006

§ 371 Date: Oct. 30, 2020

(51) Int. Cl. G01C 21/36; G06F 21/62; G06F 21/84

(52) U.S. Cl. CPC G01C 21/3641; G06F 21/84; G06F 21/6245

(57) ABSTRACT

It is an object of the present invention to set concealment targets suited to a user, as to a display of a display device mounted on a vehicle, without requiring user's time and effort. A navigation device includes a communication unit for receiving a classification criterion in accordance with an attribute of a user, from a server, a classification unit for classifying the display information into the confidential information and the non-confidential information on the basis of the classification criterion received by the communication unit, and a display control unit for performing a display control of a display device so that the confidential information and the non-confidential information should be displayed in a first display mode and the confidential information should not be displayed and the non-confidential information should be displayed in a second display mode.

### TECHNICAL FIELD

The present invention relates to a display control of a display device mounted on a vehicle.

### BACKGROUND ART

A vehicle is equipped with a variety of devices (hereinafter, referred to as “in-vehicle devices”) such as a navigation device or an audio device. Each of these in-vehicle devices incorporates a display device as a user interface or uses a separate display device mounted on the same vehicle as a user interface, and displays display information on the display device.

In recent years, proposed has been an in-vehicle device which classifies the display information into confidential information and non-confidential information and has a display mode for concealing the confidential information and displaying the non-confidential information. When any person other than an owner (user) of a vehicle uses the vehicle, for example, it is thereby possible to conceal information which the owner does not want to be known by the other person. The confidential information includes personal information such as a telephone directory or the like, and besides, information relating to preferences such as genre search history of music or the like, and the target of the confidential information increases.

Patent Document 1 discloses an in-vehicle device in which spots which were set as destinations in the past are targets to be concealed (concealment targets), and particularly in Paragraph [0044], it is described that a user explicitly determines a spot which is a concealment target, out of registered spots.

### PRIOR ART DOCUMENTS

### Patent Documents

[Patent Document 1] Japanese Patent Application Laid Open Gazette No, 2017-167043

### SUMMARY

### Problem to be Solved by the Invention

There is a problem, however, that it requires time and effort for the user to select the concealment target one by one from a variety of display information. The present invention is intended to solve the above problem, and it is an object of the present invention to set concealment targets suited to a user, as to a display of a display device mounted on a vehicle, without requiring user's time and effort.

### Means to Solve the Problem

The present invention is intended for a display control device for performing a display control of a display device mounted on a vehicle. According to the present invention, the display control device includes a receiving unit for receiving a classification criterion used for classifying display information of the display device into confidential information and non-confidential information, in accordance with an attribute of a user, from a server in which the classification criterion is managed for each attribute of the user, a classification unit for classifying the display information into the confidential information and the non-confidential information on the basis of the classification criterion received by the receiving unit, and a display control unit for performing a display control of the display device so that the confidential information and the non-confidential information are displayed in a first display mode and the confidential information is not displayed and the non-confidential information is displayed in a second display mode.

### Effects of the Invention

The display control device according to the present invention receives the classification criterion in accordance with the attribute of the user from the server and classifies the display information into the confidential information and the non-confidential information on the basis of the classification criterion, and it is therefore possible to set the concealment targets suited to the user without requiring user's time and effort. These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing a constitution of a display control system in accordance with a first preferred embodiment;

FIG. 2 is a view showing standard classification criteria;

FIG. 3 is a view showing user attributes in the standard classification criteria;

FIG. 4 is a view showing an exemplary display of a navigation menu in a confidential mode;

FIG. 5 is a view showing an exemplary display of a landmark setting screen in a non-confidential mode;

FIG. 6 is a view showing an exemplary display of the landmark setting screen in the confidential mode;

FIG. 7 is a flowchart showing a confidential classification process and a display control process by the display control system of the first preferred embodiment;

FIG. 8 is a flowchart showing details of the confidential classification process by the display control system of the first preferred embodiment;

FIG. 9 is a view showing a confidential information setting screen in a state where setting of confidential information has been made in accordance with the standard classification criteria;

FIG. 10 is a view showing a state where a registered place is set as the confidential information in the confidential information setting screen;

FIG. 11 is a flowchart showing an update process of the standard classification criterion by a server;

FIG. 12 is a view showing a standard concealment criterion;

FIG. 13 is a view showing an updated standard concealment criterion;

FIG. 14 is a view showing a hardware constitution of a display control device; and

FIG. 15 is a view showing another hardware constitution of the display control device.

### DESCRIPTION OF EMBODIMENT(S)

### A. The First Preferred Embodiment

<A-1. Constitution>

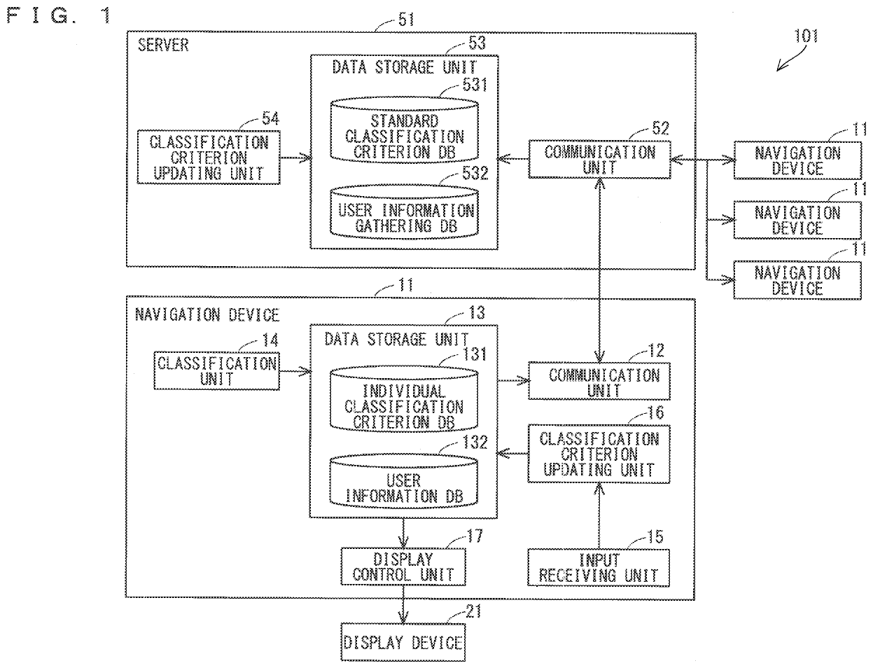

FIG. 1 is a block diagram showing a constitution of a display control system 101 in accordance with the first preferred embodiment. The display control system 101 comprises a server 51 and a plurality of navigation devices 11 connected to the server 51. The server 51 and each of the navigation devices 11 are connected to each other, for example, via the internet. The navigation device 11 is a device mounted on a vehicle and controls a display of a display device 21 mounted on the same vehicle. Display information of the navigation device 11 is displayed on a display screen of the display device 21, and the navigation device 11 is a display control device for controlling a display of the display device 21. In the present preferred embodiment, description will be made, using the navigation device 11 as an example of the display control device. The display device 21 is, for example, a liquid crystal display (LCD) or an organic EL (electroluminescence) display. Each navigation device 11 is assigned to a user in one-to-one correspondence. The navigation device 11 has a general navigation function, and besides has a function of making hands-free calling by connecting with a cellular phone terminal such as a smartphone or the like and an AV (Audio Visual) function of playing music, or the like. Further, the “device mounted on a vehicle” in the present specification includes not only a device which is constantly mounted on the vehicle but also a device which is carried into the vehicle and used therein as necessary.

First, a constitution of the navigation device 11 will be described. The navigation device 11 comprises a communication unit 12, a data storage unit 13, a classification unit 14, an input receiving unit 15, a classification criterion updating unit 16, and a display control unit 17.

The communication unit 12 performs transmission/reception of data through a communication unit 52 of the server 51 and the internet. The communication unit 12 is formed of, for example, a communication interface compliant with the wireless LAN standard or the like.

The data storage unit 13 comprises an individual classification criterion database (DB) 131 storing therein individual classification criteria and a user information database (DB) 132 storing therein user information. The individual classification criterion is a piece of data serving as a criterion used when the classification unit 14 classifies display information into confidential information and non-confidential information. The classification unit 14 classifies the display information into the confidential information and the non-confidential information in accordance with the individual classification criteria. The individual classification criteria are equal to standard classification criteria which the communication unit 12 receives from the server 51 in an initial state, and can be updated in accordance with an input operation of the user. The user information are various kinds of information which the navigation device 11 needs, other than the individual classification criteria. The user information includes, for example, attribute information of the user, unclassified display information, a classification result of the display information, and the like. The attribute information of the user is information indicating the attributes of the user, such as age, gender, and the like. Information of “male in his twenties”, for example, is the attribute information of the user.

The input receiving unit 15 is an input interface which receives the input operation of the user to the navigation device 11. The input receiving unit 15 is formed of, for example; a touch panel or a mechanical switch. Though the display device 21 is an external constituent of the navigation device 11 in FIG. 1, the display device 21 may be a constituent element of the navigation device 11. In that case, the display device 21 and the input receiving unit 15 may be integrally configured as a touch panel.

In accordance with the input operation of the user, the classification criterion updating unit 16 changes the classification of the display information and updates the individual classification criterion in accordance with the classification state after being changed.

The display control unit 17 determines whether a display mode of the navigation device 11 is a confidential mode (first display mode) or a non-confidential mode (second display mode), and causes the display device 21 to perform a display in accordance with the display mode. The confidential mode is also referred to as a valet mode. In the confidential mode, only the non-confidential information is displayed. In the non-confidential mode, both the confidential information and the non-confidential information are displayed.

Thus, the navigation device 11 is configured. Further, though four navigation devices 11 are connected to the server 51 in FIG. 1, the number of navigation devices 11 connected to the server 51 is not limited to this (four).

Next, a constitution of the server 51 will be described. The server 51 comprises a communication unit 52, a data storage unit 53, and a classification criterion updating unit 54. The communication unit 52 is a communication interface which performs transmission reception of data with the communication unit 12 of the navigation device 11. The communication unit 52 acquires the attribute of the user of the navigation device 11 and a classification status of the display information in the navigation device 11, from the communication unit 12. The communication unit 52 transmits a standard classification criterion in accordance with the attribute of the user of the navigation device 11, to the communication unit 12.

The data storage unit 53 comprises a standard classification criterion database (DB) 531 storing therein standard classification criteria and a user information gathering database (DB) 532 storing therein user information of a plurality of navigation devices 11. In the user information gathering DB 532, the attribute information of the user and the classification status of the display information which are acquired from each navigation device 11 are stored as the user information. The classification criterion updating unit 54 grasps a classification trend of the display information, which is common to the users who have the same attribute, from the user information stored in the user information gathering DB 532, and makes the standard classification criterion on the basis of the classification trend. Further, after making the standard classification criterion, when the communication unit 52 acquires another user information from the navigation device 11, the classification criterion updating unit 54 updates the standard classification criterion on the basis of the user information as appropriate.

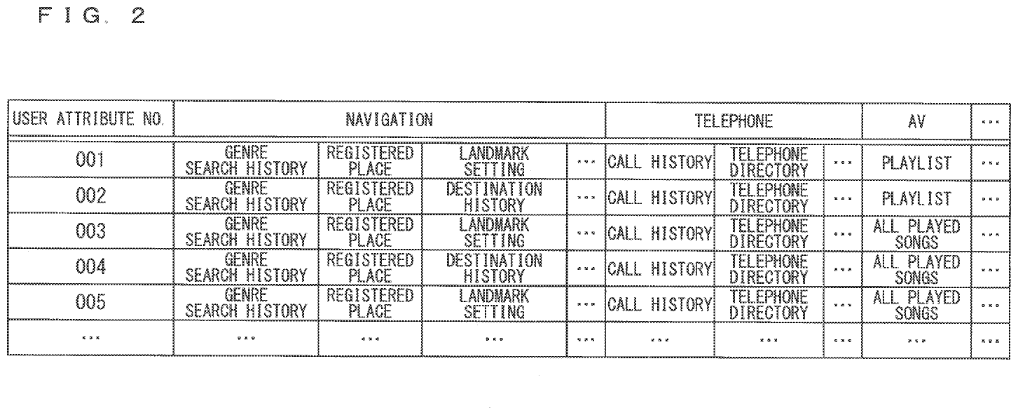

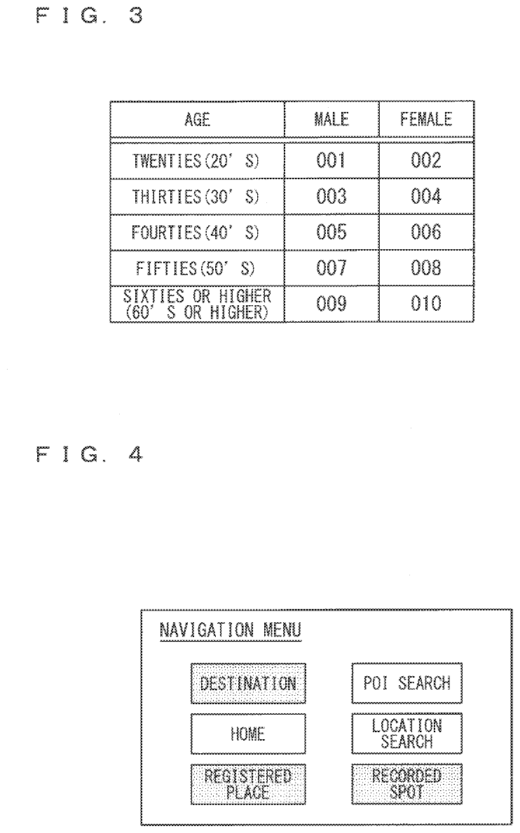

FIG. 2 is a view showing a standard classification criterion table stored in the standard classification criterion DB 531. In the standard classification criterion table, several pieces of confidential information are listed for each of the functions of the navigation device 11, such as navigation, telephone, AV, and the like. Further, in the standard classification criterion table, the attribute information of the user is shown as “User Attribute No.”. FIG. 3 is a view showing a user attribute No. management table stored in the standard classification criterion DB 531. As shown in FIG. 3, the user attribute No. is assigned for each combination of age and gender. For example, the user attribute No, “001” indicates a male in his twenties. Specifically, the standard classification criterion table shown in FIG. 2 indicates that in a case where the user attribute is “Male in his Twenties”, the confidential information as to the navigation function includes “Genre Search History”, “Registered Place”, and “Landmark Setting”. Further, in a case where the user attribute is “Female in her Twenties”, the confidential information as to the navigation function includes “Genre Search History”, “Registered Place”, and “Destination History”. Thus, in the standard classification criterion table, the standard classification criteria are determined for each attribute of the user. Further, in the standard classification criterion table of FIG. 2, the standard classification criteria are shown by listing several pieces of confidential information. In the standard classification criterion table, however, the standard classification criteria may be shown by listing several pieces of non-confidential information.

The “Genre Search History” refers to a history of searches for a destination, which the user performed in the past, from the genre of facility, such as “Movie Theater”, “Parking Lot”, or the like. When the “Genre Search History” is the confidential information, an icon relating to the genre search history is not displayed or cannot be operated by the user in the confidential mode. The “Registered Place” refers to a spot registered by the user, such as user's home or workplace, or the like. FIG. 4 is a view showing an exemplary screen display in a case where operations on the concealment targets are invalid. In the exemplary case shown in FIG. 4, since “Destination”, “Registered Place”, and “Recorded Spot” among the items in the navigation menu are set as the concealment targets, the icons used for operating these items are displayed in gray and any operation thereon is invalid.

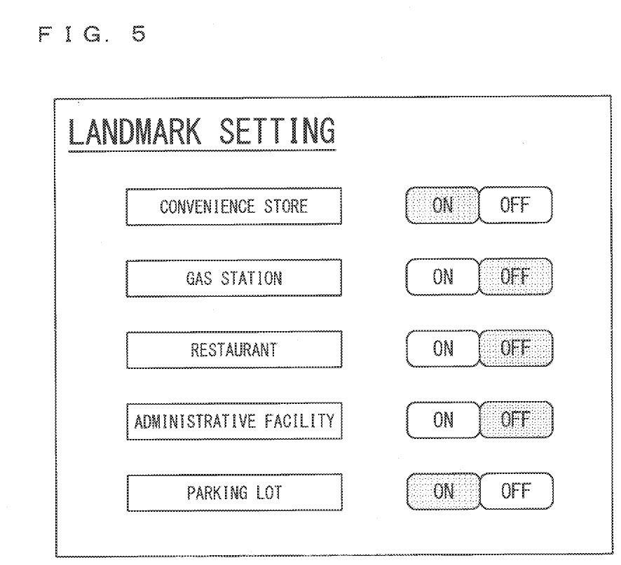

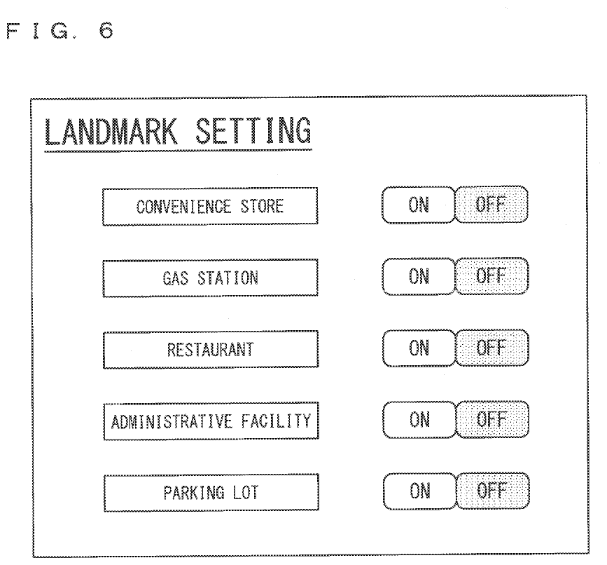

The “Landmark Setting” refers to setting as to a genre of a landmark to be displayed on a map. Though all landmarks are not displayed in the default setting, the User can change the setting so that a given genre of landmark should be displayed. FIG. 5 is a view showing a landmark setting screen displayed on the display device 21. In the exemplary case shown in FIG. 5, as the landmark, displayed are “Convenience Store”, “Gas Station”, “Restaurant”, “Administrative Facility, and “Parking Lot”. When the user often uses a convenience store and a parking lot, the user can set to display these places on the map by turning on the “Convenience Store” and the “Parking Lot” as shown in FIG. 5. When the “Landmark Setting” is the confidential information, the navigation device 11 sets the landmark setting as default. At that time, as shown in FIG. 6, all the types of landmarks are set “OFF” in the landmark setting screen.

Thus, as to how to deal with the concealment target in the confidential mode, supposed is (1) not-displaying of the related icon or the like, (2) invalidation of any operation on the related icon or the like, (3) change of the setting details back to the default, or the like.

<A-2. Operation>

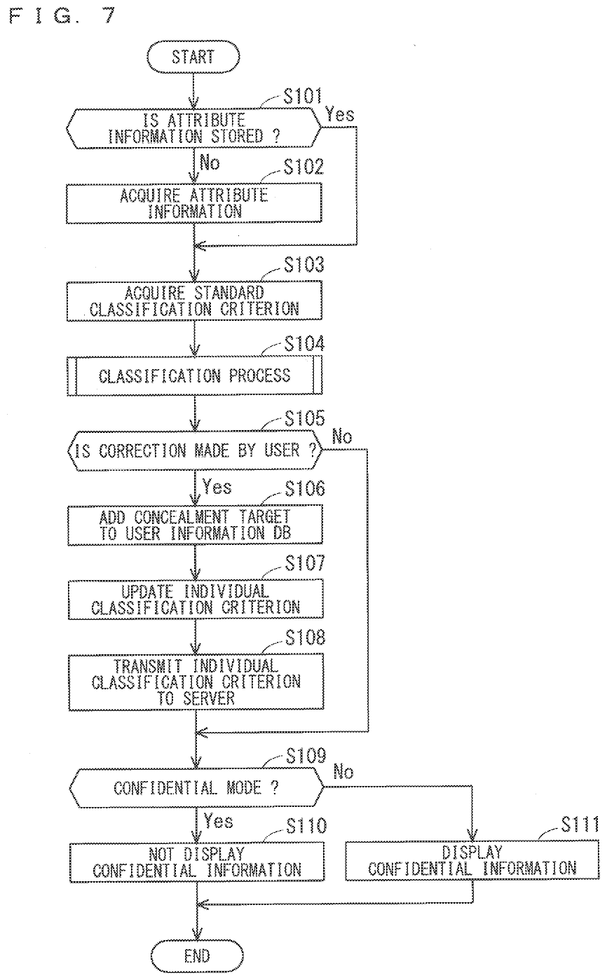

FIG. 7 is a flowchart showing a classification process and a display control process of the display information, which are performed by the navigation device 11. Hereinafter, with reference to FIG. 7, the classification process and the display control process of the display information, which are performed by the navigation device 11, will be described. The flowchart of FIG. 7 starts, for example, at the timing when an accessory power supply of the vehicle is turned on.

First, the navigation device 11 determines whether or not the attribute information of the user is stored in the user information DB 132 (Step S101). When the attribute information of the user is not stored in the user information DB 132, the navigation device 11 acquires the attribute information of the user (Step S102). Herein, the display control unit 17 causes the display device 21 to display an input screen of the attribute information, and the input receiving unit 15 acquires the attribute information inputted by using the input screen and stores the attribute information into the user information DB 132. Alternatively, the communication unit 12 may perform a wireless communication with a portable terminal such as a smartphone or the like which the user carries, to thereby acquire the attribute information of the user which the portable terminal has. In this case, the communication unit 12 is implemented by a communication interface compliant with the short-range wireless communication standard, such as Bluetooth (registered trademark) or the like.

When the attribute information of the user is stored in the user information DB 132 in Step S101, or after executing Step S102, the communication unit 12 acquires the standard classification criterion from the server 51 (Step S103), Herein, first, the communication unit 12 transmits the attribute information of the user to the communication unit 52 of the server 51 and requests the server 51 to provide the standard classification criterion in accordance with the attribute of the user. When the server 51 receives the attribute information of the user from the communication unit 12, the server 51 takes out the standard classification criterion in accordance with the attribute of the user from the standard classification criterion DB 531 and transmits the standard classification criterion from the communication unit 52 to the communication unit 12 of the navigation device 11. Thus, the communication unit 12 acquires the standard classification criterion from the server 51. The standard classification criterion is stored as the individual classification criterion into the individual classification criterion DB 131.

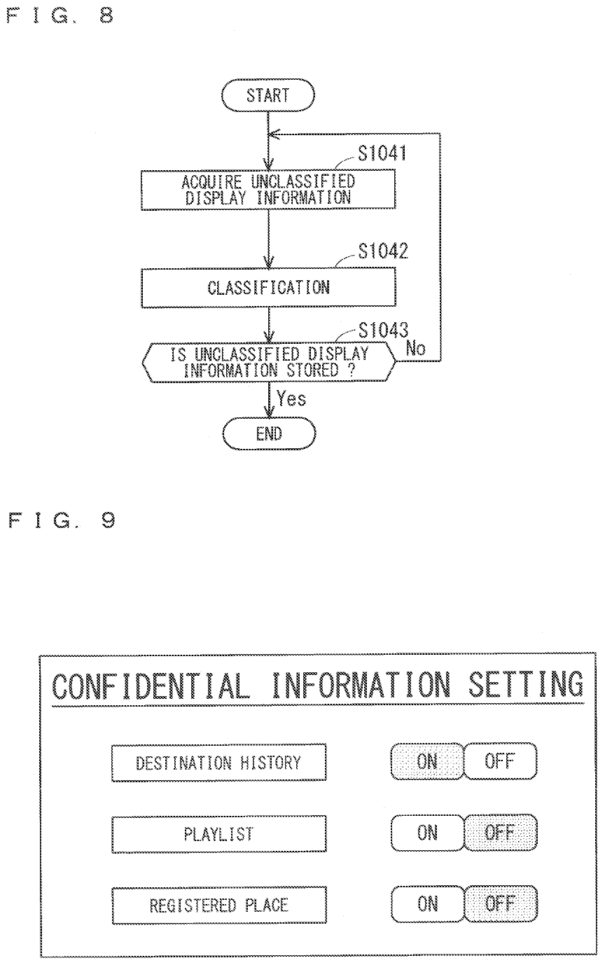

Next, the classification unit 14 classifies unclassified display information stored in the user information DB 132 into the confidential information and the non-confidential information in accordance with the individual classification criterion stored in the individual classification criterion DB 131 (Step S104). With reference to the flowchart of FIG. 8, details of the classification process in Step S104 will be described. First, the classification unit 14 acquires the unclassified display information from the user information DB 132 (Step S1041). Then, the classification unit 14 classifies the display information acquired in Step S1041 into the confidential information and the non-confidential information in accordance with the individual classification criterion (Step S1042), and stores a classification result into the user information DB 132. Next, the classification unit 14 determines whether or not there is unclassified display information in the user information DB 132 (Step S1043). When there is unclassified display information, the classification unit 14 acquires the unclassified display information from the user information DB 132 again (Step S1041) and classifies the display information (Step S1042). When there is no unclassified display information, the classification process (Step S104) performed by the classification unit 14 is ended.

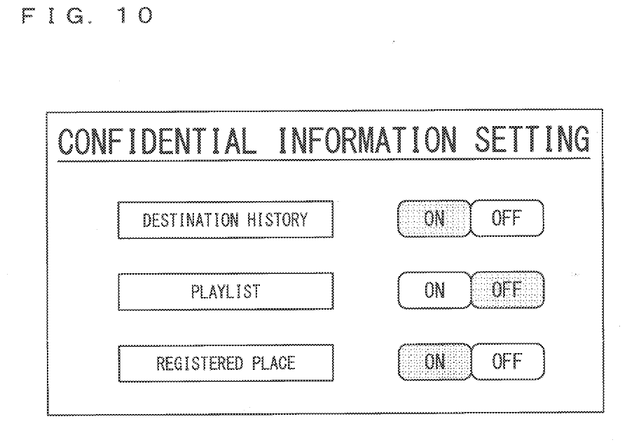

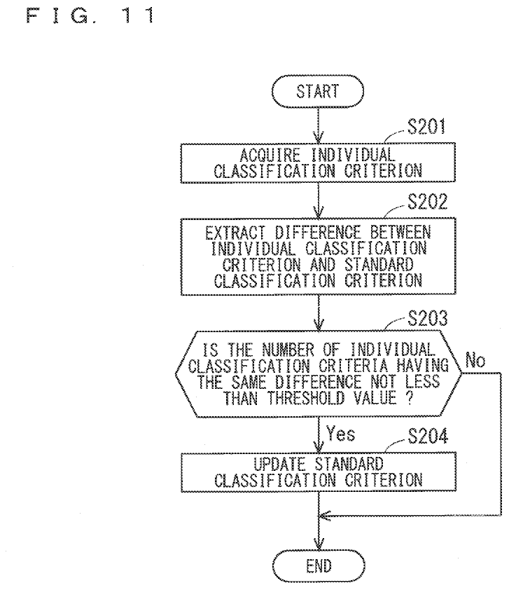

Next, the classification criterion updating unit 16 determines whether or not any correction of the classification result is made by the user (Step S105). Herein, the display control unit 17 causes the display device 21 to display such a confidential information setting screen as shown in FIG. 9. When the user performs an input operation in the confidential information setting screen, the operation content is inputted to the classification criterion updating unit 16 through the input receiving unit 15. At that time, the classification criterion updating unit 16 determines that there is a correction of the classification result in Step S105. In the exemplary case shown in FIG. 9, the “Destination History” is “ON” and this indicates that the destination history is the confidential information. From the confidential information setting screen, the user can grasp the current classification status. In a case where the user intends to make the “Registered Place” the confidential information, for example, the user brings the “Registered Place” to “ON” on the confidential information setting screen as shown in FIG. 10. In response to the user operation, the classification criterion updating unit 16 updates the classification result of the “Registered Place” in the user information stored in the user information DB 132, from the non-confidential information to the confidential information (Step S106). Further, the classification criterion updating unit 16 updates the classification result of the “Registered Place” also in the individual classification criterion stored in the individual classification criterion DB 131, to the confidential information (Step S107).

Next, the communication unit 12 transmits the updated individual classification criterion together with the attribute information of the user to the communication unit 52 of the server 51 (Step S108). Then, the display control unit 17 determines whether the display mode of the navigation device 11 is the confidential mode or not (Step S109). When the display mode of the navigation device 11 is the confidential mode, the display control unit 17 controls the display device 21 to not display the confidential information and display only the non-confidential information (Step S110). When the display mode of the navigation device 11 is the non-confidential mode, the display control unit 17 controls the display device 21 to not display the confidential information and display only the non-confidential information (Step S111). The above is the operation of the navigation device 11.

Next, with reference to the flowchart of FIG. 1 an update process of the standard classification criterion performed by the server 51 will be described. In Step S108 of FIG. 7, transmission of the individual classification criterion to the server 51 by the navigation device 11 has been described. The communication unit 52 of the server 51 thereby acquires the individual classification criterion of the navigation device 11 together with the attribute information of the user (Step S201). The individual classification criterion and the attribute information of the user which are acquired in Step S201 are stored in the user information gathering DB 532 of the data storage unit 53.

Next, the classification criterion updating unit 54 compares the individual classification criterion acquired in Step S201 with the standard classification criterion having the same attribute information of the user as that of the individual classification criterion and extracts the difference therebetween (Step S202). It is assumed, for example, that the standard classification criterion indicates that the “Genre Search History” and the “Destination History” are the confidential information, as shown in FIG. 12, Herein, it is assumed that the individual classification criterion acquired from the navigation device 11 indicates that “Genre Search History”, the “Destination History”, and the “Registered Place” are the confidential information. In this case, the “Registered Place” is the difference between the individual classification criterion and the standard classification criterion.

Next, the classification criterion updating unit 54 determines whether or not the number of individual classification criteria Which have the difference extracted in Step S202 is not less than a threshold value (Step S203). Specifically, the server 51 acquires the individual classification criteria from the plurality of navigation devices 11 and the individual classification criteria are stored in the user information gathering DB 532. Then, the classification criterion updating unit 54 determines whether or not the number of individual classification criteria indicating that the “Registered Place” is the confidential information, among the individual classification criteria stored in the user information gathering DB 532, is not less than the threshold value.

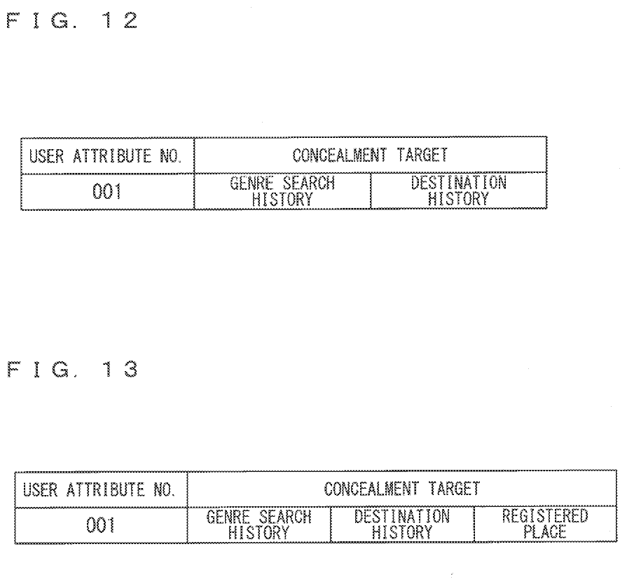

When “Yes” in Step S203, the classification criterion updating unit 54 updates the standard classification criterion in accordance with the individual classification criterion (Step S204). Specifically, the classification criterion updating unit 54 updates the standard classification criterion so that the “Registered Place” should be included in the confidential information as shown in FIG. 13. Thus, the update process of the standard classification criterion performed by the server 51 is ended.

Further, in the above description, as the method of concealing the confidential information, the display of the display device 21 is controlled. The navigation device 11, however, may conceal the confidential information by controlling an audio output of a speaker mounted on the vehicle, such as not performing the audio output of the confidential information, as well as by the display control.

<A-3. Effects>

The navigation device 11 which is the display control device of the first preferred embodiment performs a display control of the display device 21 mounted on a vehicle. The navigation device 11 comprises the communication unit which is a receiving unit for receiving a classification criterion used for classifying display information of the display device 21 into confidential information and non-confidential information, in accordance with an attribute of a user, from the server 51 in which the classification criterion is managed for each attribute of the user, the classification unit 14 for classifying the display information into the confidential information and the non-confidential information on the basis of the classification criterion received by the communication unit 12, and the display control unit 17 for performing the display control of the display device 21 so that the confidential information and the non-confidential information should be displayed in the first display mode and the confidential information should not be displayed and the non-confidential information should be displayed in the second display, mode. It is therefore possible to perform the classification of the display information, which is suited to the user, without requiring user's time and effort.

In the navigation device 11, the classification unit 14 updates the classification of the display information in accordance with the user operation. Therefore, the user can correct the classification of the display information which is automatically set by the navigation device 11, in accordance with user's own preferences.

In the navigation device 11, the attribute of the user includes at least age or gender. Therefore, according to the navigation device 11, it is possible to perform the classification of the display information which reflects preferences common to users having the same age or gender.

The display control system 101 of the first preferred embodiment comprises a plurality of navigation devices 11 which are the display control devices each for controlling a display of the display device 21 mounted on a vehicle and the server 51 for managing a classification criterion used for classifying display information which is information to be displayed on the display device 21 into confidential information and non-confidential information, for each attribute of a user. Each of the navigation devices 11 comprises the communication unit 12 which is a receiving unit for receiving the classification criterion in accordance with an attribute of a user from the server 51, the classification unit 14 for classifying the display information into the confidential information and the r on-confidential information on the basis of the classification criterion received by the communication unit 12, and the communication unit 12 which is a transmitting unit for transmitting a classification status of the display information and attribute information indicating the attribute of the user to the server 51, and the display control unit 17 for performing a display control of the display device 21 so that the confidential information and the non-confidential information should be displayed in the first display mode and the confidential information should not be displayed and the non-confidential information should be displayed in the second display mode. The server 51 updates the classification criterion for each attribute of the user on the basis of the classification status and the attribute information of the user which are acquired from the plurality of navigation devices 11. Therefore, according to the display control system 101, it is possible to perform the classification of the display information, which is suited to the user, without requiring user's time and effort.

The display control method of the first preferred embodiment is a display control method of the display device 21 mounted on a vehicle, which is performed by the server 51 and the navigation device 11 that is the display control device. The display control method of the first preferred embodiment comprises the steps of managing a classification criterion used for classifying display information of the display device 21 into confidential information and non-confidential information, for each attribute of a user, by the server 51, receiving the classification criterion in accordance with the attribute of the user from the server 51, by the navigation device 11, classifying the display information into the confidential information and the non-confidential information on the basis of the received classification criterion, by the navigation device 11, performing a display control of the display device 21 so that the confidential information and the non-confidential information should be displayed in the first display mode and the confidential information should not be displayed and the non-confidential information should be displayed in the second display mode, by the navigation device 11, transmitting a classification status of the display information and attribute information indicating the attribute of the user to the server 51, by the navigation device 11, and updating the classification criterion for each attribute of the user on the basis of the classification status and the attribute information, by the server 51. Therefore, it is possible to perform the classification of the display information, which is suited to the user, without requiring user's time and effort.

### B. Hardware Configuration

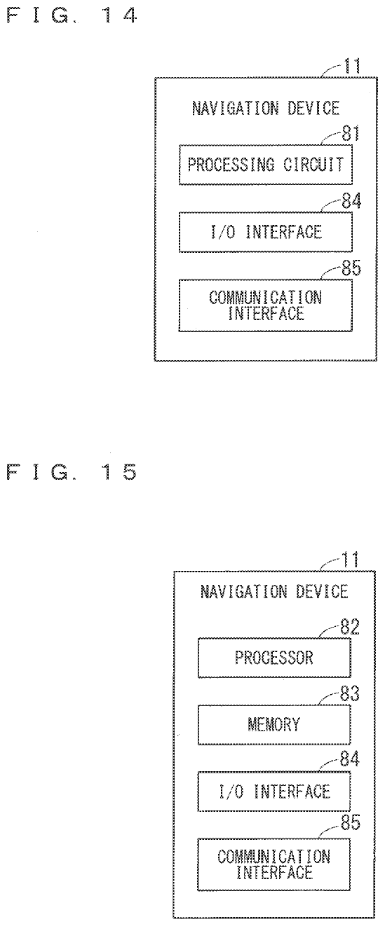

In the above-described navigation device 11, the data storage unit 13, the classification unit 14, the classification criterion updating unit 16, and the display control unit 17 are implemented by a processing circuit 81 shown in FIG. 14, the input receiving unit 15 is implemented by an I/O interface 84, and the communication unit 12 is implemented by a communication interface 85. In other words, the processing circuit 81 comprises the data storage unit 13, the classification unit 14, the classification criterion updating unit 16, and the display control unit 17 (hereinafter, referred to as “the classification unit 14 and the like”). To the processing circuit 81, a dedicated hardware may be applied, or a processor which executes a program stored in a memory may be applied. As the processor, for example, used is a central processing unit, a processing unit, an arithmetic unit, a microprocessor, a microcomputer, a DSP (Digital Signal Processor), or the like.

When the processing circuit 81 is a dedicated hardware, the processing circuit 81 corresponds to, for example, a single circuit, a complex circuit, a programmed processor, a multiple programmed processor, an ASIC (Application Specific Integrated Circuit), an FPGA (Field Programmable Gate Array), or a combination of these circuits. Respective functions of the constituent elements such as the classification unit 14 and the like may be implemented by a plurality of processing circuits 81, or these functions of the constituent elements may be collectively implemented by one processing circuit.

When the processing circuit 81 is a processor, the functions of the classification unit 14 and the like are implemented by combination with software or the like (software, firmware, or software and firmware). The software or the like is described as a program and stored in a memory. As shown in FIG. 15, a processor 82 applied to the processing circuit 81 reads out and executes the program stored in a memory 83, to thereby implement the respective functions of the constituent elements. Specifically, the navigation device 11 comprises the memory 83 which stores therein programs which are executed by the processing circuit 81 to consequently perform the step of receiving a classification criterion in accordance with an attribute of a user from a server, the step of classifying display information into confidential information and non-confidential information on the basis of the received classification criterion, the step of performing a display control of the display device so that the confidential information and the non-confidential information should be displayed in the first display mode and the confidential information should not be displayed and the non-confidential information should be displayed in the second display mode, and the step of transmitting a classification status of the display information and attribute information indicating the attribute of the user to the server. In other words, the program is executed to cause a computer to perform a procedure or a method of the classification unit 14 and the like. Herein, the memory 83 may be, for example, a nonvolatile or volatile semiconductor memory such as a RAM (Random Access Memory), a ROM (Read Only Memory), a flash memory, an EPROM (Electrically Programmable Read Only Memory), an EEPROM (Electrically Erasable Programmable Read Only Memory), or the like, a HDD (Hard Disk Drive), a magnetic disk, a flexible disk, an optical disk, a compact disk, a mini disk, or a DVD (Digital Versatile Disc) and a drive unit thereof, or the like, or every storage medium which can be used in the future.

The case has been described above where the respective functions of the classification unit 14 and the like are implemented by ogre of hardware and software or the like. This is, however, only one exemplary case, and there may be a case where some part of the classification unit 14 and the like is implemented by a dedicated hardware and the other part is implemented by software or the like. For example, there may be a case where the function of the classification unit 14 is implemented by the processing circuit as the dedicated hardware and the respective functions of the constituent elements other than the classification unit 14 are implemented when the processing circuit 81 serving as the processor 82 reads out and executes the programs stored in the memory 83.

As described above, the processing circuit can implement the above-described functions by hardware, software or the like, or combination thereof. Further, the data storage unit 13 is formed of the memory 83, and may be formed of the single memory 83 or may be formed of individual memories.

In the present invention, the preferred embodiment and variations may be freely combined, or may be changed or omitted as appropriate, without departing from the scope of the invention. While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

11 navigation device, 12 communication unit, 13 data storage unit, 14 classification unit, 15 input receiving unit, 16 classification criterion updating unit, 17 display control unit, 21 display device, 51 server, 52 communication unit, 53 data storage unit, 54 classification criterion updating unit, 81 processing circuit, 82 processor, 83 memory, 84 I/O interface, 85 communication interface, 131 individual classification criterion DB, 132 user information DB, 531 standard classification criterion DB, 532 user information gathering DB

1. A display control device for performing a display control of a display device mounted on a vehicle, comprising:
a processor to execute a program; and
a memory to store the program which, when executed by the processor, performs processes of
receiving a classification criterion used for classifying display information of the display device into confidential information and non-confidential information, in accordance with an attribute of a user, from a server in which the classification criterion is managed for each attribute of the user;
classifying the display information into the confidential information and the non-confidential information on the basis of the received classification criterion; and
performing a display control of the display device so that the confidential information and the non-confidential information are displayed in a first display mode and the confidential information is not displayed and the non-confidential information is displayed in a second display mode.

2. The display control device according to claim 1, wherein
the program, when executed by the processor, further performs processes of updating classification of the display information in accordance with an operation of the user.

3. The display control device according to claim 1, wherein
the attribute of the user includes at least age or gender.

4. A display control system, comprising:
a plurality of display control devices each for controlling a display of a display device mounted on a vehicle; and
a server for managing a classification criterion used for classifying display information which is information to be displayed on the display device into confidential information and non-confidential information, for each attribute of a user,
wherein each of the plurality of display control devices comprises:
a processor to execute a program; and
a memory to store the program which, when executed by the processor, performs processes of
receiving the classification criterion in accordance with an attribute of a user from the server;
classifying the display information into the confidential information and the non-confidential information on the basis of the received classification criterion;
transmitting a classification status of the display information and attribute information indicating the attribute of the user to the server; and
performing a display control of the display device so that the confidential information and the non-confidential information are displayed in a first display mode and the confidential information is not displayed and the non-confidential information is displayed in a second display mode, and
the server updates the classification criterion for each attribute of the user on the basis of the classification status and the attribute information which are acquired from the plurality of display control devices.

5. A display control method of a display device mounted on a vehicle, which is performed by a server and a display control device, comprising:
managing a classification criterion used for classifying display information of the display device into confidential information and non-confidential information, for each attribute of a user, by the server;
receiving the classification criterion in accordance with the attribute of the user from the server, by the display control device;
classifying the display information into the confidential information and the non-confidential information on the basis of the received classification criterion, by the display control device;
performing a display control of the display device so that the confidential information and the non-confidential information are displayed in a first display mode and the confidential information is not displayed and the non-confidential information is displayed in a second display mode, by the display control device;
transmitting a classification status of the display information and attribute information indicating the attribute of the user to the server, by the display control device; and
updating the classification criterion for each attribute of the user on the basis of the classification status and the attribute information, by the server.
